(19) United States
(12) Patent Application Publication
(10) Pub. No.: US 2015/0069020 A1
(43) Pub. Date: Mar. 12, 2015

(54) Contact Materials for High Voltage Direct Current Systems

(71) Applicant: Airbus Defence and Space GmbH, Ottobrunn (DE)

(72) Inventors: Juergen STEINWANDEL, Uhldingen-Muehlhofen (DE); Dietrich JONKE, Taufkirchen (DE); Helmut PIRINGER, Baldham (DE)

(21) Appl. No.: 14/482,873

(22) Filed: Sep. 10, 2014

(30) Foreign Application Priority Data
Sep. 11, 2013 (DE) 10 2013 014 915.0

(51) Int. Cl. H01H 33/10

(52) U.S. Cl. CPC H01H 33/10; H01H 2201/024; H01H 2201/026; H01H 2201/03; H01H 2239/044; C23C 4/127
USPC 218/146; 427/453; 427/455; 427/456; 427/450; 427/451

(57) ABSTRACT

A contact element for high voltage direct current switches includes a matrix made of a first material selected from the group comprising copper, silver, palladium, platinum, tungsten, molybdenum, rhenium, nickel, gold, and alloys thereof. The contact element also includes a foreign phase, which is dispersed in the matrix and is made of a second material selected from the group comprising carbon, tin(II) oxide, tin(IV) oxide, zinc(II) oxide, tungsten, nickel and mixtures thereof. The contact element has a porosity of ≦1.0% by volume, based on a total volume of the contact element.

### CROSS-REFERENCE TO RELATED APPLICATIONS

The present application claims priority under 35 U.S.C. §119 to German application 10 2013 014 915.0, filed Sep. 11, 2013, the entire disclosure of which is herein expressly incorporated by reference.

### BACKGROUND AND SUMMARY OF THE INVENTION

Exemplary embodiments of the present invention relate to a contact element for high voltage direct current switches, a method for producing such a contact element, as well as the use of the contact element in a high voltage direct current switch.

Contact elements and connecting points for high voltage direct current circuits (100-1,000 V) are potential weak points with respect to the occurrence of plasma arcs. Due to the formation of stationary electrical fields the formation of plasma is more critical for direct currents than for alternating AC fields, which make it difficult for plasma to form. The objective is to avoid the occurrence of plasma arcs, because the plasma arcs constitute a considerable safety risk and may be the cause for short circuits, with the risk of a total failure of the electrical system and possibly even damage by fire. This safety risk applies independently of the respective direct current source (batteries, fuel cells or alternating current rectification).

The contact elements and/or connecting points that are currently used are known predominantly from alternating current circuits. The known contact materials are, for example, silver/tin oxide, which lend themselves well for use with currents up to 50 A. On the other hand, high current switches are plasma switches, as used, for example, in power plants. Usually electronic switching elements are used for high voltage direct current switches. However, it is also necessary to use mechanical or plasma-based switches with complete electrical isolation in such circuits.

Accordingly, exemplary embodiments of the present invention are directed to a contact element and/or a connecting point that can be used in a high voltage direct current switch in such a way that there are fewer occurrences of the formation of plasma arcs than with the conventional contact elements and/or connecting points, so that the net result is a lower safety risk. Exemplary embodiments of the present invention are also directed to a method for producing such a contact element for high voltage direct current switches. In particular, this method shall exhibit a low cost due to a simplified production.

Based on the aforesaid, a first subject matter of the present invention is a contact element for high voltage direct current switches, the contact element comprising
a) a matrix made of a first material selected from the group comprising copper, silver, palladium, platinum, tungsten, molybdenum, rhenium, nickel, gold and alloys thereof;

and
b) a foreign phase, which is dispersed in the matrix and is made of a second material selected from the group comprising carbon, tin(II) oxide, tin(IV) oxide, zinc(II) oxide, tungsten, nickel and mixtures thereof, wherein the contact element has a porosity of less than or equal to ≦1.0% by volume, based on the total volume of the contact element.

The contact element according to the invention is suitable for use in a high voltage direct current switch. An additional advantage is that the contact element has a significantly reduced tendency to form plasma arcs; and/or the contact element does not exhibit any plasma arcs and, as result, offers a low safety risk.

For example, the contact element comprises the matrix in an amount of 75.0 to 99.9% by weight, based on the total weight of the contact element; and/or the contact element comprises the foreign phase in an amount of 0.1 to 25.0% by weight, based on the total weight of the contact element.

For example, the foreign phase is dispersed homogeneously in the matrix.

For example, the foreign phase, dispersed in the matrix, comprises nano particles having a diameter in a range of 100.0 to 1,000.0 nm, preferably in a range of 100.0 to 750.0 nm and even more preferred in a range of 100.0 to 500.0 nm.

For example, the contact element has a porosity of less than or equal to ≦0.5% by volume and preferably ≦0.1% by volume, based on the total volume of the contact element.

For example, the contact element is a thermally sprayed contact element.

For example, the contact element has a layer thickness between 100.0 μm and 5.0 mm, preferably between 200.0 μm and 3.0 mm, even more preferred between 250.0 μm and 2.0 mm and, in particular, between 300.0 μm and 1.0 mm.

Furthermore, the present invention provides a method for producing a contact element for high voltage direct current switches, the method comprising
a) providing a first material selected from the group comprising copper, silver, palladium, platinum, tungsten, molybdenum, rhenium, nickel, gold and alloys thereof;
b) providing a second material selected from the group comprising carbon, tin(II) oxide, tin(IV) oxide, zinc(II) oxide, tungsten, nickel and mixtures thereof,
c) bringing the first material from step a) into contact with the second material from step b), in order to produce a master alloy comprising the first material and the second material; and
d) thermally spraying the master alloy, obtained in step c), in order to produce the contact element comprising a matrix, made of the first material, and a foreign phase, which is dispersed in the matrix and is made of the second material.

For example, the first material in step a) comprises particles having a diameter in a range of 5.0 to 100.0 μm, preferably in a range of 5.0 to 50.0 μm and even more preferred in a range of 5.0 to 25.0 μm; and/or the second material in step b) comprises nano particles having a diameter in a range of 100.0 to 1,000.0 nm, preferably in a range of 100.0 to 750.0 nm and even more preferred in a range of 100.0 to 500.0 nm.

For example, the second material is carbon and is selected from the group comprising fullerenes, carbon nano tubes, graphene, graphite and mixtures thereof.

For example, the first material is provided in an amount of 75.0 to 99.9% by weight, based on the total weight of the contact element; and/or the second material is provided in an amount of 0.1 to 25.0% by weight, based on the total weight of the contact element.

For example, the bringing into contact in step c) is performed by grinding the first material with the second material.

For example, the thermal spraying in step d) is performed by cold gas spraying or plasma spraying or flame spraying.

The present invention also relates to the use of the contact element in a high voltage direct current switch. For example, in an electric power drive, preferably in an aircraft.

### BRIEF DESCRIPTION OF THE DRAWING FIGURE

FIG. 1 illustrates a contact element and contact carrier in accordance with one example of the present invention.

### DETAILED DESCRIPTION

The present invention relates to a contact element for high voltage direct current switches, the contact element comprising
a) a matrix made of a first material selected from the group comprising copper, silver, palladium, platinum, tungsten, molybdenum, rhenium, nickel, gold and alloys thereof; and
b) a foreign phase, which is dispersed in the matrix and is made of a second material selected from the group comprising carbon, tin(II) oxide, tin(IV) oxide, zinc(II) oxide, tungsten, nickel and mixtures thereof, wherein the contact element has a porosity of less than or equal to ≦1.0% by volume, based on the total volume of the contact element.

As a result, the requirement of the present invention is that the contact element comprise a matrix made of a first material selected from the group comprising copper, silver, palladium, platinum, tungsten, molybdenum, rhenium, nickel, gold and alloys thereof.

In one embodiment of the present invention the first material comprises, preferably is made of molybdenum or copper.

In an additional embodiment of the present invention the first material comprises silver or gold or palladium. For example, the first material comprises silver or gold, preferably silver.

In one embodiment of the present invention the first material is made of silver or gold or palladium. For example, the first material is made of silver or gold, preferably silver. A matrix, which is made of a first material and comprises, is preferably made of silver, has, in particular, the advantage that a contact element comprising such a matrix has a high electrical conductivity.

In one embodiment of the present invention the first material comprises an alloy. In this case the base metal is selected from one of the aforementioned elements. Correspondingly the alloy comprises preferably a first element selected from the group comprising copper, silver, palladium, platinum, tungsten, molybdenum, rhenium, nickel and gold as the base metal. Furthermore, the alloy comprises at least a second element or a second compound selected from the group comprising palladium, tungsten, tungsten carbide, carbide, nickel, nickel carbide, ruthenium, iridium, silver copper, silver nickel, cobalt, copper, carbon, silver and mixtures thereof. In this case it must be pointed out that the first element is chemically different from the second element or the second compound. For example, the first element is the alloy. That is, the base metal silver is the second element or the second compound of the alloy selected from the group comprising palladium, tungsten, tungsten carbide, carbide, nickel, nickel carbide, rhenium, iridium, silver copper, silver nickel, cobalt, copper, carbon and mixtures thereof.

If the second element of the alloy is carbon, then the carbon is selected preferably from the group comprising fullerenes, carbon nano tubes, graphene, graphite and mixtures thereof.

In one embodiment of the present invention the matrix comprises an alloy, such as Ag—Pd, Ag—Cd, AgC, Ag—WC, Ag—WC—C, Ag—Ni, AgNiC, AgCu, Ag—W, Au—Ni, Au—Co, AuAg, AuAgCu, AuAgNi, Pd—Ag, PdCu, PdRu, Ptlr, PtRu, PtW, W—Cu, Cu—W, Cu—Ag, etc.

If the first material comprises an alloy, then the alloy comprises the first element, preferably in an amount of 50.0 to 97.0% by weight, based on the total weight of the alloy. For example, the alloy comprises the first element in an amount of 60.0 to 95.0% by weight or in an amount of 70.0 to 90.0% by weight, based on the total weight of the alloy. In addition or as an alternative, the alloy comprises the second element or the second compound in an amount of 3.0 to 50.0% by weight, based on the total weight of the alloy. For example, the alloy comprises the second element or the second compound in an amount of 5.0 to 40.0% by weight or in an amount of 10.0 to 30.0% by weight, based on the total weight of the alloy.

In one embodiment of the present invention the matrix comprises an alloy, such as AgNi10, AgNi15, AgNi40, AgCu3, AgCu10, AgCu20, AgCu28, AgPd30, AgPd50, PdCu15, or PdCu40.

The amount of the matrix in the contact element can vary over a wide range.

In particular, the contact element comprises the matrix in an amount of 75.0 to 99.9% by weight, based on the total weight of the contact element. For example, the contact element comprises the matrix in an amount of 75.0 to 90.0% by weight, based on the total weight of the contact element. In one embodiment of the present invention the contact element comprises the matrix in an amount of 80.0 to 90.0% by weight, based on the total weight of the contact element.

In addition or as an alternative, the contact element comprises the foreign phase in an amount of 0.1 to 25.0% by weight, based on the total weight of the contact element. For example, the contact element comprises the foreign phase in an amount of 10.0 to 25.0% by weight, based on the total weight of the contact element. In one embodiment of the present invention the contact element comprises the foreign phase in an amount of 10.0 to 20.0% by weight, based on the total weight of the contact element.

For example, the contact element comprises the matrix in an amount of 75.0 to 99.9% by weight and the foreign phase in an amount of 0.1 to 25.0% by weight, based on the total weight of the contact element. For example, the contact element comprises the matrix in an amount of 75.0 to 90.0% by weight and the foreign phase in an amount of 10.0 to 25.0% by weight, based on the total weight of the contact element. In one embodiment of the present invention the contact element comprises the matrix in an amount of 80.0 to 90.0% by weight and the foreign phase in an amount of 10.0 to 20.0% by weight, based on the total weight of the contact element.

In one embodiment the contact element is made of the matrix in an amount of 75.0 to 99.9% by weight and the foreign phase in an amount of 0.1 to 25.0% by weight, based on the total weight of the contact element. For example, the contact element is made of the matrix in an amount of 75.0 to 90.0% by weight and the foreign phase in an amount of 10.0 to 25.0% by weight, based on the total weight of the contact element. In one embodiment of the present invention the contact element is made of the matrix in an amount of 80.0 to 90.0% by weight and the foreign phase in an amount of 10.0 to 20.0% by weight, based on the total weight of the contact element.

An additional requirement of the present invention is that the contact element exhibit a foreign phase dispersed in the matrix. In this case the foreign phase comprises a second material selected from the group comprising carbon, tin(II) oxide, tin(IV) oxide, zinc(II) oxide, tungsten, nickel and mixtures thereof. Preferably the foreign phase is made of a second material selected from the group comprising carbon, tin(II) oxide, tin(IV) oxide, zinc(II) oxide, tungsten, nickel and mixtures thereof. The use of nickel as the second material has the advantage that the contact element that is obtained has a good arc extinction property. The use of carbon and/or tin(II) oxide as the second material has the advantage that the contact element obtained has a high erosion protection; and, as a result, a uniform wear of the contacts is guaranteed.

In one embodiment of the present invention the second material comprises carbon or tin(II) oxide. For example, the second material comprises tin(II) oxide.

In one embodiment of the present invention the second material is made of carbon or tin(II) oxide. For example, the second material is made of tin(II) oxide.

If the second material is carbon, then the carbon is selected preferably from the group comprising fullerenes, carbon nano tubes, graphene, graphite and mixtures thereof.

In this case it must be pointed out that the second material is chemically different from the first material. For example, if the first material is tungsten, then the second material is selected from the group comprising carbon, tin(II) oxide, tin(IV) oxide, zinc(II) oxide, nickel and mixtures thereof.

In one embodiment of the present invention the first material of the contact element comprises silver; and the second material is selected from the group comprising carbon, tin(II) oxide, tin(IV) oxide, zinc(II) oxide, tungsten, nickel and mixtures thereof. For example, the first material of the contact element comprises silver; and the second material comprises carbon or tin(II) oxide, preferably tin(II) oxide. Preferably the first material of the contact element is made of silver; and the second material is made of carbon or tin(II) oxide, preferably tin(II) oxide.

It is particularly advantageous for the contact element, if the foreign phase is dispersed homogeneously in the matrix.

For example, the foreign phase, dispersed in the matrix, comprises nano particles.

The term “nano particles” may be construed, according to the present invention, as particles having particle sizes in the nanometer to micrometer range. In one embodiment the foreign phase, dispersed in the matrix, comprises nano particles having a diameter in a range of 100.0 to 1,000.0 nm. For example, the foreign phase, dispersed in the matrix, comprises nano particles having a diameter in a range of 100.0 to 750.0 nm or in a range of 100.0 to 500 nm. The use of nano particles has the advantage that it contributes to a homogeneous dispersion of the foreign phase in the matrix.

According to the present invention, the contact element has a porosity of less than or equal to 1.0% by volume, based on the total volume of the contact element. A low porosity is advantageous, since it leads to a reduction in or avoidance of the occurrence of an arc formation, and the contact element that is obtained has a high erosion protection and, as a result, offers a lower safety risk. Furthermore, a uniform dispersion of the graphite in the matrix can be obtained by grinding the graphite onto the matrix material.

In one embodiment of the present invention, the contact element has a porosity of less than or equal to ≦0.5% by volume, based on the total volume of the contact element. For example, the contact element has a porosity of ≦0.1% by volume, based on the total volume of the contact element.

A porosity of ≦1.0% by volume, preferably ≦0.5% by volume and even more preferred ≦0.1% by volume, based on the total volume of the contact element, is preferably obtained in the contact element, in that the contact element is produced by a thermal spraying process. Correspondingly the inventive contact element is preferably a thermally sprayed contact element.

The layer thickness of the contact element is in ranges that are typical for this element. For example, the contact element has a layer thickness between 100.0 μm and 5.0 mm. In an additional embodiment the contact element has a layer thickness between 200.0 μm and 3.0 mm, even more preferred between 250.0 μm and 2.0 mm and, in particular, between 300.0 μm and 1.0 mm.

The present invention also relates to a method for producing a contact element for high voltage direct current switches. The inventive method for producing a contact element for high voltage direct current switches, as described above, comprises at least the steps:
a) providing a first material selected from the group comprising copper, silver, palladium, platinum, tungsten, molybdenum, rhenium, nickel, gold and alloys thereof;
b) providing a second material selected from the group comprising carbon, tin(II) oxide, tin(IV) oxide, zinc(II) oxide, tungsten, nickel and mixtures thereof,
c) bringing the first material from step a) into contact with the second material from step b), in order to produce a master alloy comprising the first material and the second material; and
d) thermally spraying the master alloy, obtained in step c), in order to produce the contact element comprising a matrix, made of the first material, and a foreign phase, which is dispersed in the matrix and is made of the second material.

In one embodiment of the present invention the method for producing a contact element for high voltage direct current switches consists of the steps:
a) providing a first material selected from the group comprising copper, silver, palladium, platinum, tungsten, molybdenum, rhenium, nickel, gold and alloys thereof;
b) providing a second material selected from the group comprising carbon, tin(II) oxide, tin(IV) oxide, zinc(II) oxide, tungsten, nickel and mixtures thereof,
c) bringing the first material from step a) into contact with the second material from step b), in order to produce a master alloy comprising the first material and the second material; and
d) thermally spraying the master alloy, obtained in step c), in order to produce the contact element comprising a matrix, made of the first material, and a foreign phase, which is dispersed in the matrix and is made of the second material.

This method offers the advantage over the past conventional melt metallurgical and powder metallurgical processes that there is no need for a complex production of intermediate products, such as sintered ingots, and their extensive further processing by rolling, drawing and/or extrusion. Moreover, the contact element can be sprayed directly on the carrier that is used, so that there is no need to solder the contact element on the corresponding carrier; and/or there is no need for punching and stamping processes, in order to produce the individual parts. Therefore, the present method has a low cost due to a simplified production. Moreover, one advantage of sprayed contact elements as compared to extruded contact elements is that there is no need for intermediate annealing steps, in order to dissolve the cold hardening, which is a consequence of high degrees of deformation and stretching, so that the material will become “free flowing” again. In the spraying process these steps are omitted, because the contact element is constructed in a generative manner layer by layer, a process that is not carried out by means of forming steps with tools.

In one embodiment of the method according to the invention, step a) comprises providing a first material, as described above.

Working on this basis, one requirement of the present invention is that a first material selected from the group comprising copper, silver, palladium, platinum, tungsten, molybdenum, rhenium, nickel, gold and alloys thereof is provided.

In one embodiment of the present invention the first material comprises, is preferably made of, molybdenum or copper.

In an additional embodiment of the present invention the first material comprises silver or gold or palladium. For example, the first material comprises silver or gold, preferably silver.

In one embodiment of the present invention the first material is made of silver or gold or palladium. For example, the first material is made of silver or gold, preferably silver.

In one embodiment of the present invention the first material comprises an alloy. In this case the base metal is selected from one of the aforementioned elements. Correspondingly the alloy comprises preferably a first element selected from the group comprising copper, silver, palladium, platinum, tungsten, molybdenum, rhenium, nickel and gold as the base metal. Furthermore, the alloy comprises at least a second element or a second compound selected from the group comprising palladium, tungsten, tungsten carbide, carbide, nickel, cobalt, copper, carbon, silver and mixtures thereof. In this case it must be pointed out that the first element is chemically different from the second element or the second compound. For example, the first element is the alloy. That is, the base metal silver is the second element or the second compound of the alloy selected from the group comprising palladium, tungsten, tungsten carbide, carbide, nickel, nickel carbide, rhenium, iridium, silver copper, silver nickel, cobalt, copper, carbon and mixtures thereof.

If the second element of the alloy is carbon, then the carbon is selected preferably from the group comprising fullerenes, carbon nano tubes, graphene, graphite and mixtures thereof.

In one embodiment of the present invention the alloy comprises, for example, Ag—Pd, Ag—Cd, AgC, Ag—WC, Ag—WC—C, Ag—Ni, AgNiC, AgCu, Ag—W, Au—Ni, Au—Co, AuAg, AuAgCu, AuAgNi, Pd—Ag, PdCu, PdRu, PtIr, PtRu, PtW, W—Cu, Cu—W, Cu—Ag, etc.

If the first material comprises an alloy, then the alloy comprises the first element preferably in an amount of 50.0 to 97.0% by weight, based on the total weight of the alloy. For example, the alloy comprises the first element in an amount of 60.0 to 95.0% by weight or in an amount of 70.0 to 90.0% by weight, based on the total weight of the alloy. In addition or as an alternative, the alloy comprises the second element or the second compound in an amount of 3.0 to 50.0% by weight, based on the total weight of the alloy. For example, the alloy comprises the second element or the second compound in an amount of 5.0 to 40.0% by weight or in an amount of 10.0 to 30.0% by weight, based on the total weight of the alloy.

In one embodiment of the present invention the matrix comprises an alloy, such as AgNi10, AgNi15, AgNi40, AgCu3, AgCu10, AgCu20, AgCu28, AgPd30, AgPd50, PdCu15, or PdCu40.

In addition or as an alternative, the first material has a certain particle size. According to this embodiment, the first material in step a) comprises particles having a diameter in a range of 5.0 to 100.0 μm. For example, the first material in step a) comprises particles having a diameter in a range of 5.0 to 50.0 μm or of 5.0 to 25.0 μm.

In one embodiment of the present invention the first material in step a) is made of particles having a diameter in a range of 5.0 to 100.0 μm. For example, the first material in step a) is made of particles having a diameter in a range of 5.0 to 50.0 μm or of 5.0 to 25.0 μm.

In one embodiment of the present invention the first material is provided as a powder.

The first material is provided preferably in an amount of 75.0 to 99.9% by weight, based on the total weight of the contact element. For example, the first material is provided in an amount of 75.0 to 90.0% by weight, based on the total weight of the contact element. In one embodiment of the present invention the first material is provided in an amount of 80.0 to 90.0% by weight, based on the total weight of the contact element.

Furthermore, one requirement, according to step b) of the method according to the invention, is that a second material selected from the group comprising carbon, tin(II) oxide, tin(IV) oxide, zinc(II) oxide, tungsten, nickel and mixtures thereof be provided.

In one embodiment of the present invention the second material comprises carbon or tin(II) oxide. For example, the second material of the foreign phase comprises tin(II) oxide.

In one embodiment of the present invention the second material is made of carbon or tin(II) oxide. For example, the second material is made of tin(II) oxide.

If the second material is carbon, then the carbon is selected preferably from the group comprising fullerenes, carbon nano tubes, graphene, graphite and mixtures thereof.

In addition or as an alternative, the second material has a certain particle size. According to this embodiment, the second material in step b) comprises nano particles. For example, the second material in step b) comprises particles having a diameter in a range of 100.0 to 1,000.0 nm. For example, the second material in step b) comprises particles having a diameter in a range of 100.0 to 750.0 nm or of 100.0 to 500.0 nm.

It must be pointed out that the second material is chemically different from the first material. For example, if tungsten is provided as the first material, then the second material that is to be provided is a material selected from the group comprising carbon, tin(II) oxide, tin(IV) oxide, zinc(II) oxide, nickel and mixtures thereof.

In addition or as an alternative, the second material is provided in an amount of 0.1 to 25.0% by weight, based on the total weight of the contact element. For example, the second material is provided in an amount of 10.0 to 25.0% by weight, based on the total weight of the contact element. In one embodiment of the present invention the second material is provided in an amount of 10.0 to 20.0% by weight, based on the total weight of the contact element.

In one embodiment of the present invention the second material is provided as a powder. Preferably the first material and the second material are provided as a powder.

As already stated above, it is especially advantageous, if the foreign phase made of the second material is dispersed, preferably homogeneously, in the matrix, i.e. the first material. This measure is achieved, in particular, by the fact that the first material is brought into contact with the second material, in order to produce a master alloy comprising the first material and the second material, preferably made of the first material and the second material.

A dispersion, preferably a homogeneous dispersion, of the foreign phase, i.e. the second material, in the matrix, i.e. the first material, is achieved preferably by the fact that the first material is brought into contact with the second material in step c) by grinding the first material with the second material.

Methods for grinding materials are known in the prior art. For example, the grinding of the first material with the second material can be carried out in a mill that is suitable for this purpose, such as an attritor mill, ball mill, etc. The second material can be rubbed onto the particles of the first material by means of this step and, as a result, can lead to a homogeneous dispersion of the foreign phase in the matrix. This process is usually performed at temperatures of preferably not more than 100° C. for preferably less than 10 minutes. For example, this process is performed at room temperature, i.e. approx. 18 to 24° C., for preferably less than 10 minutes.

As an alternative, the first material can be brought into contact with the second material in step c) by chemically bonding the second material to the first material by means of conventional adjuvants. Such so-called “cladding methods” are known in the prior art.

Bringing the first material into contact with the second material in step c) is used, in particular, for producing a master alloy comprising the first material and the second material, preferably made of the first material and the second material. In this case it must be pointed out that the master alloy, which is obtained in this step, exhibits a preferably homogeneous dispersion of the second material in the first material.

According to step d) of the present invention, the master alloy for producing the contact element is thermally sprayed. For example, the thermal spraying is performed by cold gas spraying or plasma spraying or flame spraying.

For example, the thermal spraying in step d) is carried out by means of flame spraying. In one embodiment of the present invention the flame spraying is carried out by high speed flame spraying. The flame spraying process and the high speed flame spraying process are known in the prior art. In particular, this process is carried out at temperatures of preferably more than 800° C. In one embodiment of the present invention the process temperature is greater than or equal to the melting temperature of the powder material to be processed.

As an alternative, the thermal spraying in step d) is performed by means of plasma spraying. Plasma spraying methods are known in the prior art. In particular, this thermal spraying is carried out in the normal pressure range or in the low pressure range. Thermal spraying in the low pressure range has the advantage that a homogeneous dispersion of the foreign phase, i.e. the second material, in the matrix, i.e. the first material, can be achieved. If the plasma spraying process is carried out in the low pressure range, then the plasma spraying process is performed preferably in a range of 0.01 to 1 bar. The plasma is generated preferably by guiding a process gas through an arc, which burns continuously inside the plasma torch. A process gas that lends itself well for such a use is a gas selected from the group comprising argon, nitrogen, helium, hydrogen or mixtures thereof. For example, a process gas that lends itself well for such a use is a mixture of argon and helium and optionally nitrogen. As an alternative, a mixture of argon and hydrogen and optionally nitrogen is used as the process gas. The plasma spraying process is carried out at temperatures of preferably more than 800° C.

As an alternative, the thermal spraying in step d) is performed by means of cold gas spraying. Cold gas spraying processes are known in the prior art. In this case a protective gas is accelerated to ultrasonic speed; and the master alloy comprising the first material and the second material is injected into the gas jet. The net result of this approach is that the master alloy, which is injected into the gas jet, is accelerated to a speed that is so high that the master alloy does not have to be partially or totally melted beforehand. A protective gas that lends itself well for such a use is preferably a gas selected from the group comprising nitrogen, helium, compressed air or mixtures thereof. For example, compressed air is used as the protective gas. The use of compressed air takes place preferably in a pressure range of 30 to 70 bar, for example, in a pressure range of 30 to 60 bar. As an alternative, a mixture of nitrogen and helium is used as the protective gas. The cold gas spraying technique offers many advantages. First of all, contact elements are obtained with a very low porosity, preferably with a porosity of ≦0.5% by volume, and even more preferred ≦0.1% by volume, based on the total volume of the contact element. Secondly the contact elements that are produced in this way have a very dense layer that exhibits a high hardness, so that a high degree of adhesion to the carrier materials can be achieved with the layer. Furthermore, oxidation of the first and/or second material in the master alloy is avoided by means of the cold gas spraying technique. An additional advantage of the cold gas spraying technique is that a contact element with a graduated proportion of the second material in the first material can be produced.

Due to the advantages offered by the contact element according to the invention, the present invention also relates to the use of the contact element in a high voltage direct current switch. In one embodiment of the present invention, the contact element is used in an electric power drive. For example, the contact element is used in an electric power drive of an aircraft. As stated above, the contact element according to the invention can significantly reduce the occurrence of the formation of plasma arcs; and/or the contact element according to the invention does not exhibit the occurrence of plasma arcs. The net result is that the safety risk associated with the use of the contact element is reduced.

### EXAMPLES

A contact element comprising a matrix of silver and a foreign phase, which is dispersed in the matrix and is made of tin(II) oxide, was produced, as explained below. 80% by volume and 20% by volume of tin(II) oxide powder, based on the total volume of the mixture, were mixed by grinding in the dry state. The mixture was sprayed onto a contact carrier strip made of copper by means of a cold gas spraying system at 40 bar and by means of nitrogen as the process gas. The copper carrier strip was first polished and then brushed prior to spraying on the mixture of silver and tin(II) oxide. The application of the silver/tin(II) oxide mixture by spraying was performed in a vacuum for the purposes of a homogeneous dispersion of the foreign phase, i.e. tin(II) oxide, in the silver matrix. The contact element that was obtained in this way was then punched and stamped.

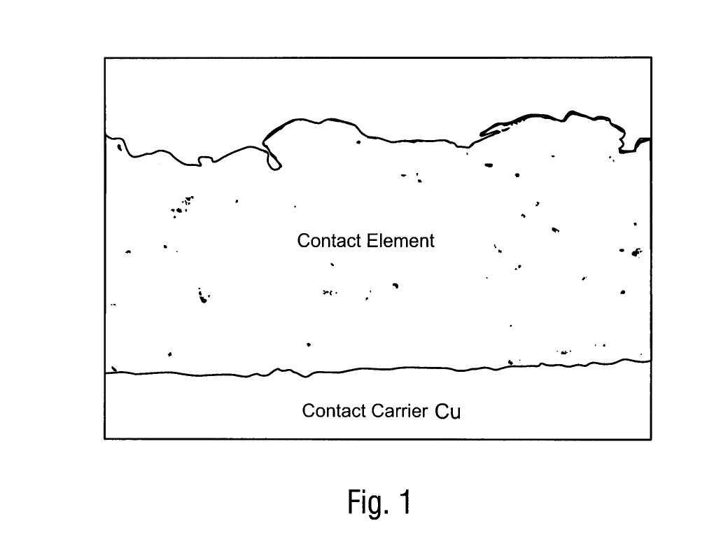

The visual inspection of the contact element by means of a micrographic analysis showed that that contact element has a porosity of 1.0% by volume, based on the total volume of the contact element; see also FIG. 1. The particles of the foreign phase have a diameter of 5 to 35 μm. Furthermore, an adhesion of approx. 80 MPa to the carrier strip was determined for the contact element, so that there is very high adhesion to the carrier material. The adhesion was determined by means of the Acceptable Quality Level (AQL) method (statistical control procedure) in accordance with DIN 50014.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A contact element for high voltage direct current switches, the contact element comprising:
a) a matrix made of a first material selected from the group comprising copper, silver, palladium, platinum, tungsten, molybdenum, rhenium, nickel, gold, and alloys thereof; and
b) a foreign phase, which is dispersed in the matrix and is made of a second material selected from the group comprising carbon, tin(II) oxide, tin(IV) oxide, zinc(II) oxide, tungsten, nickel and mixtures thereof,
wherein the contact element has a porosity of ≦1.0% by volume, based on a total volume of the contact element.

2. The contact element of claim 1, wherein the contact element comprises
the matrix in an amount of 75.0 to 99.9% by weight, based on the total weight of the contact element; and/or
the foreign phase in an amount of 0.1 to 25.0% by weight, based on the total weight of the contact element.

3. The contact element of claim 1, wherein the foreign phase is dispersed homogeneously in the matrix.

4. The contact element of claim 1, wherein the foreign phase dispersed in the matrix comprises nano particles having a diameter in a range of 100.0 to 1,000.0 nm.

5. The contact element of claim 1, wherein the foreign phase dispersed in the matrix comprises nano particles having a diameter in a range of 100.0 to 750.0 nm.

6. The contact element of claim 1, wherein the foreign phase dispersed in the matrix comprises nano particles having a diameter in a range of 100.0 to 500.0 nm.

7. The contact element of claim 1, wherein the contact element has a porosity of ≦0.5% by volume based on the total volume of the contact element.

8. The contact element of claim 1, wherein the contact element has a porosity of ≦0.1% by volume based on the total volume of the contact element.

9. The contact element of claim 1, wherein the contact element is a thermally sprayed contact element.

10. The contact element of claim 1, wherein the contact element has a layer thickness between 100.0 μm and 5.0 mm.

11. The contact element of claim 1, wherein the contact element has a layer thickness between 300.0 μm and 1.0 mm.

12. The contact element of claim 1, wherein the contact element is a component of a high voltage direct current switch.

13. The contact element of claim 12, wherein the high voltage direct current switch is a component of an electric power drive of an aircraft.

14. A method for producing a contact element for high voltage direct current switch, the method comprising:
a) providing a first material selected from the group comprising copper, silver, palladium, platinum, tungsten, molybdenum, rhenium, nickel, gold and alloys thereof;
b) providing a second material selected from the group comprising carbon, tin(II) oxide, tin(IV) oxide, zinc(II) oxide, tungsten, nickel and mixtures thereof,
c) bringing the first material from step a) into contact with the second material from step b) to produce a master alloy comprising the first material and the second material; and
d) thermally spraying the master alloy obtained in step c) to produce the contact element comprising a matrix, made of the first material, and a foreign phase, which is dispersed in the matrix and is made of the second material.

15. The method of claim 14, wherein the first material in step a) comprises particles having a diameter in a range of 5.0 to 100.0 μm; and/or the second material in step b) comprises nano particles having a diameter in a range of 100.0 to 1,000.0 nm.

16. The method of claim 14, wherein the second material is carbon and is selected from the group comprising fullerenes, carbon nano tubes, graphene, graphite and mixtures thereof.

17. The method of claim 14, wherein the first material is provided in an amount of 75.0 to 99.9% by weight, based on a total weight of the contact element; and/or the second material is provided in an amount of 0.1 to 25.0% by weight, based on the total weight of the contact element.

18. The method of claim 14, wherein the bringing into contact in step c) is performed by grinding the first material with the second material.

19. The method of claim 14, wherein the thermal spraying in step d) is performed by cold gas spraying or plasma spraying or flame spraying.
